(19) United States
(12) Patent Application Publication
(10) Pub. No.: US 2003/0121025 A1
(43) Pub. Date: Jun. 26, 2003

(54) Method and system for combining multiple software test generators

(76) Inventors: Eitan Farchi, Pardes Hana (IL); Paul Kram, Lowell, MA (US); Yael Shaham-Gafni, Cupertino, CA (US); Shmuel Ur, Shorashim (IL)

Correspondence Address: Mark D. Simpson, Esquire, Synnestvedt & Lechner, 2600 Aramark Tower, 1101 Market Street, Philadelphia, PA, 19107-2950, US

(21) Appl. No.: 09/946,255

(22) Filed: Sep. 5, 2001

(51) Int. Cl. G06F 9/44; G06F 9/45

(52) U.S. Cl. 717/124; 717/146; 717/151

(57) ABSTRACT

The present invention allows tests generated by multiple test generators to be merged into a comprehensive test specification, allowing multiple test generators to work together as a single unit, and allowing tests from multiple test generators to be combined to achieve a single defined testing goal.

A novel test generation framework is disclosed in which the test compilation and test optimization processes of the prior art are utilized in connection with a novel combining process (a framework) to allow the combining of testing tools of different formats. The test compilation and test optimization processes work with an “intermediate test representation,” which is simply an intermediate step during which models of differing formats are disguised to “hide” their format; and instructions directing the appropriate execution order of the disguised models are developed and utilized. By disguising their format, the test engine can read and run the models and combine the different testing tools and obtain an abstract test representation that is far superior to that available using prior art tools. In the intermediate test representation, some portions of the overall test are “partially specified” when they are received from the test optimization process, in contrast to the abstract test representation which is fully instantiated.

### CROSS REFERENCE TO RELATED APPLICATIONS

The present patent application is related to concurrently filed patent application number 09/xxx,xxx entitled Methods System, and Computer Program Product for Automated Test Generation for Nondeterministic Software Using State Transition Rules and owned by the assignee of the present invention.

### BACKGROUND OF THE INVENTION

In view of the explosive growth of software development and the use of computer software in all aspects of life, from telephone and electrical service to devices as simple as microwave ovens, the need to reliably test software has never been greater. The amount of software being produced is growing exponentially, and the time allowed for development and testing of that software is decreasing exponentially. Throughout the software industry, efforts are being made to reduce the time required to develop and test computer software.

Many attempts are being made to develop methods of automated testing and modeling of software systems. Prior attempts at developing automated testing methods have reduced the human labor involved in test execution, but do little, if anything, to improve the effectiveness of the testing.

Almost all test generators work from some form of abstract model. This can be a state chart, a grammar, an attribute language, or some other formalism. Abstraction is how humans organize and comprehend complexity, especially in computer systems. A formal model can be created to capture and test a portion of a system's behavior using an abstraction tailored to that specific purpose. The model itself represents the properties of the system as viewed through the lens of the abstraction; these properties are referred to herein as the “properties of interest” and represent only the aspects which are the focus of the particular test. All detail outside of the focus of the abstraction is omitted from the model. For example, one model might be directed solely towards a method of selecting a port of a particular server being accessed; another model might be directed solely towards testing the various methods of designating an IP address of a particular server. While each of these models function appropriately for the specific task with which they are associated, the overall testing of a software program using these specific models may suffer from the narrow focus of these models, since no other aspects will be tested using these models.

Models are created that capture the properties of interest in representational form (such as a modeling language); this form is readily parsed by human modelers and by test generation devices. A conventional test generation device generates many abstract tests from a model, and because the models are incomplete, the abstract tests based on these models underspecify (relative to the modeled system as a whole) the tests to be executed. This inherent incompleteness of abstract tests generated from deliberately incomplete models conflicts with the desire to fully and thoroughly test the entire program. This is a fundamental problem for which there are well known but somewhat flawed solutions described herein.

The omissions in an abstract test specification may be deliberately or incidentally added by the test execution engine at runtime. For example, a test execution engine may specify (hardcode) the values for test mapping of test threads to processes; however, the programmer doing the hardcoding may inadvertently omit the value that controls the timing of the execution (assuming that neither of these properties is explicitly specified by the test model). This may result in the test being unable to locate defects because the execution timing may be critical to the test execution. Other runtime properties of a test's execution that are completely outside of the scope of the test model may be deliberately or inadvertently omitted; once again, these omissions may limit or destroy the value of the test procedure.

When a test generator does not adeptly generate some properties of a model, they too can be hard coded into the model and passed through to the abstract tests. Further, it may be necessary to hard-code a discrete parameter value into a model when a test generator does not automatically select optimal parameter values from a continuous range of values.

Though hard coded values may be used in many different abstract tests, any part of the abstract test that is hard coded into the model will not result in an optimal result since there is no flexibility with respect to the hard-coded parameters; this may require significant human intervention to account for the inadequacies of the model.

What software designers end up with when using prior art test generators are large sets of effective but very narrow-use and incompatible testing tools which perform different functions. In a typical test generation environment, a library of test generation tools will be available for use by the tester. The test process will typically involve “test optimization” and “test compilation.” Test optimization is the process of selecting testing tools from the library to perform a desired battery of tests directed to the properties of interest. The selected tests are then used to perform their particular test functions, thereby obtaining test results in the form of output data. Once the appropriate testing tools are selected during the test optimization process, the “test compilation” process takes place. Test compilation is the process of combining the output data of the battery of testing tools that were selected. All of the test generation tools will not be of the same format in current environments, since different test generators originate from different vendors. As a result, special translators are required to translate from one format to the other as part of the compilation process.

Thus, as described above, the prior methods of automated test generation tend to be narrowly focused on testing of a particular aspect of a program, and efforts to combine and leverage the advantages of these methods has been ad hoc and labor intensive. Further progress in the area of improving the speed and effectiveness of automated testing depends on the emergence of automated test generation throughout the life cycle of the software design process. In addition, as discussed above, using prior art test systems, testing tools of one format are incompatible with testing tools of another format. Thus, the test optimization process only allows selection of testing tools of the same format and are thus limited to the functionality of these tests. The results of tests performed using two different, incompatible test systems may be compared manually by a human observer of the results, but no automated test systems exist which enable the integration of incompatible testing tools to produce thorough and accurate test results. Although a test of another format might be more appropriate to handle a particular aspect of the overall test process desired by the tester, prior art systems simply do not allow the intermingling of testing tools of different formats. None of these solutions of the prior art can optimally test software from a global perspective; they only focus on their respective properties of interest, to the exclusion of all other properties. Thus, it would be desirable to have a testing solution that enabled the various solutions of the prior art to be automatically executed and integrated to operate together to optimize the testing process.

### SUMMARY OF THE INVENTION

The present invention implements a standardized and extensible method for the integration and combination of present and future software test generators, and enables a plurality of independently developed test generators of different formats to work together and to be controlled as a single encompassing unit.

The present invention allows tests generated by multiple test generators to be merged into a comprehensive test specification, allowing multiple test generators to work together as a single unit, and allowing tests from multiple test generators to be combined to achieve a single defined testing goal.

The present invention comprises a novel test generation framework in which the test compilation and test optimization processes of the prior art are utilized in connection with a novel combining process (a framework) to allow the combining of testing tools of different formats. In accordance with the present invention, the test compilation and test optimization processes work with an “intermediate test representation,” which is simply an intermediate step during which models of differing formats are disguised to “hide” their format; and instructions directing the appropriate execution order of the disguised models are developed and utilized. By disguising their format, the test engine can read and run the models and combine the different testing tools and obtain an abstract test representation that is far superior to that available using prior art tools. In the intermediate test representation, some portions of the overall test are “partially specified” when they are received from the test optimization process, in contrast to the abstract test representation which is fully instantiated.

### BRIEF DESCRIPTION OF THE DRAWINGS

FIG. 1 illustrates an example of a test generation framework architecture in accordance with the present invention; and

FIG. 2 illustrates an example of a “map” showing the processing steps to be performed in connection with the present invention.

### DETAILED DESCRIPTION OF THE PREFERRED EMBODIMENTS

A preferred embodiment will now be described in greater detail with respect to the figures. The preferred embodiment presented in this disclosure is meant to be exemplary and not meant to limit or restrict the invention to the illustrated embodiment.

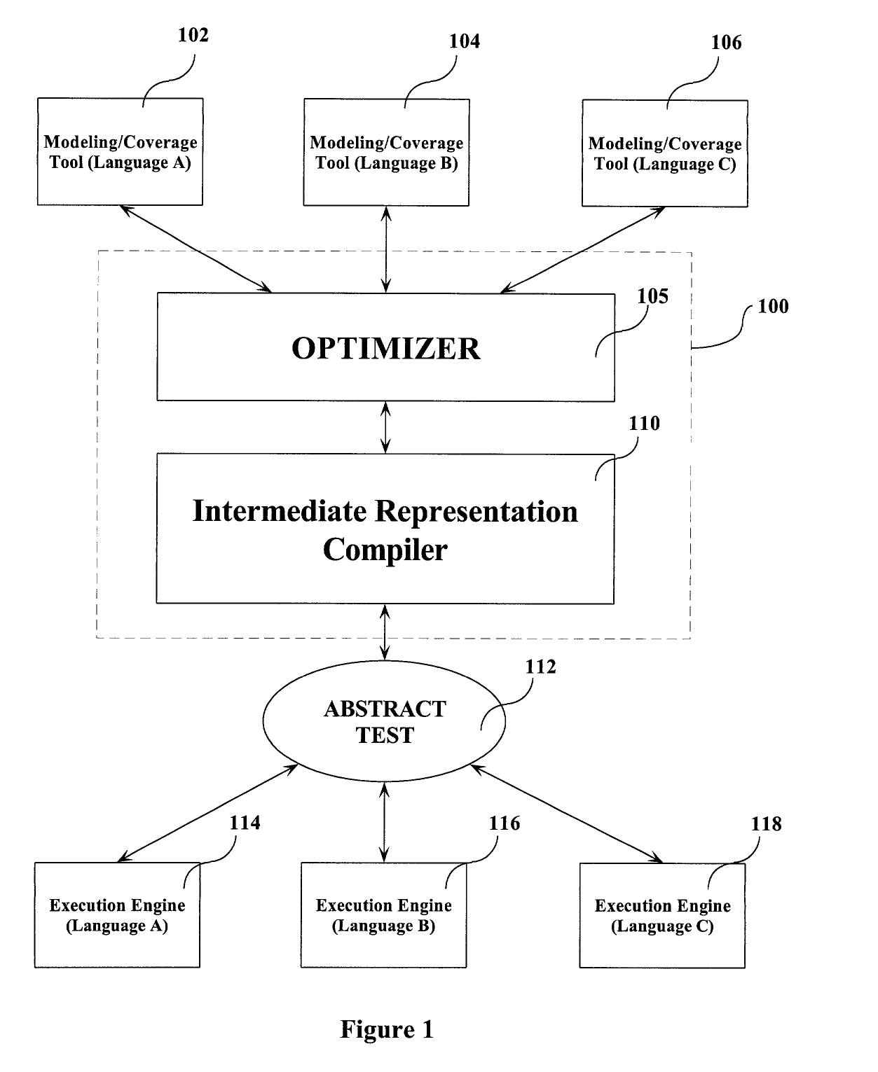

FIG. 1 illustrates an example of a test generation framework architecture in accordance with the present invention. A test generation management processor 100 performs test optimization by selecting appropriate tools from a set of modeling/coverage tools 102, 104, and 106. Modeling/coverage tools 102, 104, and 106 each generate specific modeling types in languages consistent with the tool used to generate the model. For example, modeling/coverage tool 102 generates a model in language A; modeling/coverage tool 104 generates a model in language B; and modeling/coverage tool 106 generates a model in language C. As discussed above, while each of these modeling/coverage tools may generate important and useful models, due to the incompatibility of the languages in which they generate the models, they cannot easily be combined using prior art methods. The present invention solves this problem.

The test generation management processor 100 in accordance with the present invention comprises an optimizer 105 and an Intermediate Representation Compiler 110. In order for the present invention to function properly, the output from the optimizer 105 must be in the language/format of the intermediate representation compiler 110. The optimizer 105 can be configured, for example, to take any “format-specific” models (e.g., from model/coverage tools 102, 104, 106) and convert the format-specific aspects of them to a generic format, such as a cookie, so that all inputs to the intermediate representation compiler 110 are stripped of any format-specific elements. For example, if optimizer 105 selects a model from each of the three generation tools 102, 104, and 106, it will receive models in three different languages: language A, language B, and language C, respectively. The instructions in the various languages will be specific to the particular language and thus will be incomprehensible to the other generation tools; these aspects are converted by optimizer 105 to convert them into a generic format, such as a cookie. Essentially, designations (e.g., “<framework>” and “</framework>”) are placed around the engine-specific instructions; anything within the designations is considered as text only, rather than as a command instruction. The designations define the beginning and ending of the cookie.

To enable the disguised instructions to be able to be appropriately processed at the appropriate time, the Intermediate Representation Compiler 110 inserts directives to identify the appropriate sequence and action for processing the contents of the cookie. The result is a series of computer instructions, referred to herein as an “intermediate representation,” which can be processed by the framework, with the incompatible portions of the modeling embedded in the instructions in the form of, in this example, a cookie.

Once processed by the intermediate representation compiler 110, these models are “exploded”, that is, the cookie is opened and the format-specific aspects contained therein are executed to perform their specific function. By iterating the models through the optimizer 105 and intermediate representation compiler 110, all of the disguised models are run; the result is an abstract test 112 that can be executed by a test driver in a well-known manner. Thus, modeling tools and coverage tools of varying languages/formats can be utilized to produce abstract tests which gain the benefit of the various abstractions performed by the various modeling tools and coverage tools. The abstract test so created can then be used by any test driver for which the abstract test is formally defined.

The modeling tools are outside of the test generation management processor 100, i.e., they are not part of the test generation framework itself. A modeling tool is a tool that receives as input a model description (a description of the details of the model in the language specific to a particular test generation tool) and its output is generated test data. So that the test generation management processor 100 can work with a specific modeling generation tool, either the generation tool output must be in the format of (i.e., meet the language specification of) the intermediate test representation or the test generation management processor 100 must be able to transform the output of this specific modeling generating tool into an intermediate test representation. The Intermediate Representation Compiler 110 performs this translation using well-known techniques.

An execution engine is a driver that executes abstract tests on the program under test. In order to work with the test generation framework of the present invention, either the execution engine must be able to work directly on the framework abstract test representation (i.e., the final result) or there must be a straightforward transformation from the abstract test representation to the input representation needed by the test engine. In other words, the output of the test generation framework must be in a format that is understandable or usable by the test engine.

Tests may be compiled in batch mode, and then passed to the execution engine, or alternatively, tests can be generated in an interactive mode, allowing the results of test execution to be fed back to the framework to further refine the test compilation and optimization process.

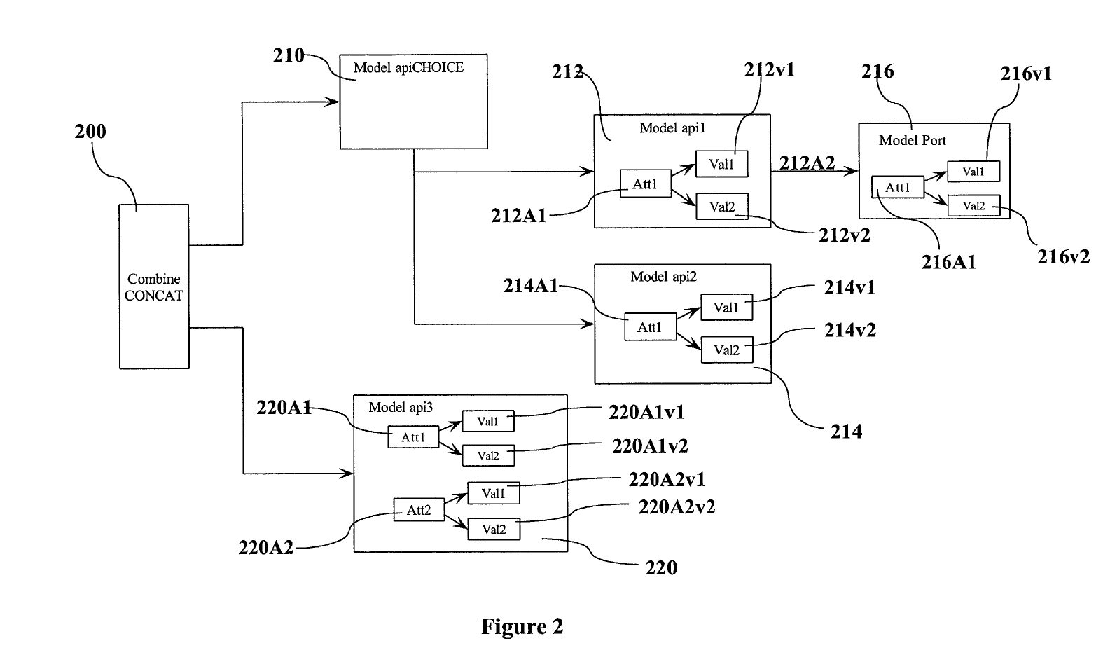

The following example illustrates and demonstrates the test generation framework concept of the present invention and its intended use. The example will first be described in general functional terms; it will then be described in more detail referring to FIG. 2; finally, it will be explained by conducting a “walk-through” of the entire process.

In this example, it is desired to test the various ways of connecting a processing computer to a server so that certain actions can be performed on files residing on the server. A test engine called “SID” runs, among other things, a model called “apiCHOICE,” and a test engine called “FOCUS” runs, among other things, models called “api1”, “api2”, “api3”, and “port.” Each of these models perform different functions; in this example, “port” is a model that models two different methods of selecting a port to be accessed within the specified server (e.g., either a default port or a user-specified port). Models api1 and api2 each model two different methods of specifying which particular server is to be contacted (e.g., either by using the numeric IP address or the mnemonic domain name). Model apiCHOICE models the selection between using model api1 or model api2 (the differences between using api1 and api2 will become apparent after the following discussion). Finally, model api3 models several methods of accessing a file on the contacted server (e.g., whether to open a file to write to the file or open a file to read the file; whether to open the file at the beginning of the file or open the file at the end of the file).

The present invention combines the results of the various test generation tools listed above in an automatic and efficient manner thereby allowing a test to be performed which considers multiple methods of accessing files on a server. Since the SID models and the FOCUS models are incompatible, they cannot be efficiently combined using prior art techniques. In other words, the SID-format model apiCHOICE cannot select nor run FOCUS-format api1, api2, api3, or port.

However, the present invention makes it possible to efficiently combine the results of these models. In accordance with the present invention, the test generation management processor 100 creates an abstract test that efficiently covers the various ways in which a server can be contacted and specific files on the server can be accessed and possibly modified. A series of generic directives (described below in detail) are used to coordinate the operation of the various models so that the appropriate execution engines are called up to execute the particular models in the most efficient manner.

The first step in the process is the identification of the desired “coverage criteria” for the program under test. Coverage criteria typically comprise an informal list of tasks to be accomplished by the test suite being developed. From the coverage criteria, the overall processes to be performed by the various test generators is “mapped out” and then, based on analysis of the resultant map, the sequence of operation of the various test generators needed to execute all of the processes is determined.

The sequence will include operations being performed by incompatible test generators. Thus, so that errors are not generated caused by an attempt being made by a particular test generator to run an incompatible operation, in accordance with the present invention, the above-mentioned generic directives are implemented which “hide” the engine-specific elements of the models which would otherwise cause the running of these operations. This process is called creating an “intermediate representation”. Essentially, the intermediate representation places the engine-specific elements in a “black box” or “cookie” format whereby the specific elements are ignored by the framework until the black box or cookies are “exploded” to reveal their specific operations individually.

FIG. 2 illustrates an example of a “map” showing the processing steps to be performed in connection with the above-described example. A directive 200 called “CombineCONCAT” directs the test generation management processor 100 to combine and concatenate the results received from the SID-format model 210 called apiCHOICE and the FOCUS-format model 220 called api3. The CombineCONCAT directive is explained in more detail below. The SID-format model 210, since it is called upon to process the results from two FOCUS-format models 212 and 214 (api1 and api2), receives a directive from the test generation management processor 100 to obtain the models 212 and 214 from the FOCUS engine and run them. However, before model 210 can process models 212 and 214, model 216 (“port”) must first be processed, since it is embedded in model 212 (as described below, model 216 is an “attribute” or variable of model 212 and is thus considered to be embedded therein).

The model “port” has an attribute 216A1 which is a variable defining how a particular port is identified for access, and in this example, two possible values, 216v1 and 216v2 provide possible values for the variable identified by attribute 216A1. Specifically, in this example, value 216v1 identifies a default port, and value 216v2 identifies a user-specified port number. Thus, model 216 functions to test these two particular methods of determining which port to access.

Model 212, as mentioned previously, is utilized to model various methods of accessing the appropriate server. In this example, attribute 212A1 is a variable identifying the process of selecting an IP address of a particular server, value 212v1 identifies a value for attribute 212A1 indicating that the numeric IP address will be used to identify the server, and value 212v2 identifies a value for 212A1 in which the domain name is used to identify the IP address. Note further that the model 216 (“port”) is “embedded” in model 212 as a variable, 212A2, so identified by the designation along the arrow between model 212 and model 216.

Model 214 is essentially the same as model 212, in that this model simply models the two methods of identifying the IP address; however, rather than specifying either the default or user-specified port number as performed by model 216, in model 214, once the IP addresses have been identified, all ports on the identified server are searched to determine which port is appropriate for the task at hand, using known port-searching methods. Thus, model 214 covers the situation where the identity of the port is not known.

Model 220 requires identification of two variables, attribute 220A1, which identifies the purpose of accessing a particular file on the designated server (e.g., reading or writing), and attribute 220A2, which identifies where within the identified file to begin the process (e.g., at the beginning or end) identified by 220A1. In this example, value 220A1v1 tests the opening of a file for the purpose of writing to the file, and value 220A1v2 tests the opening of a specific file for the purpose of reading the file. Value 220A2v1 tests the process for opening the file at its beginning, and value 220A2v2 is utilized to test the process for opening the file at the end of the file.

The test identified in FIG. 2 has essentially two legs, the apiCHOICE (model 210) leg and the api3 (model 220) leg. Once these models are fully exploded, resulting in a complete abstract test, the abstract test results are combined using the directive CombineCONCAT 200. Specifically, the number of elements in the Cartesian product of the results of model 210 and model 220 (A1 and A2) is a product of the number of elements in these results; thus, this Cartesian product is typically very large. CombineCONCAT 200 is a subset of this Cartesian product and has a size which is equal to the maximum size of the elements of models 210 and 220. In this way, the size of the final abstract test can be controlled to a manageable level.

The following tables illustrates an example of the input to the framework with respect to the example mapped out in FIG. 2.

The input to the test generation management processor 100 is one template test:

TABLE 1
<test set>

<test>

<framework directive=CombineCONCAT>

<set>
<generator engine=SID model=apiCHOICE> </generator>
</set>
<set>
<generator engine=FOCUS model=api3> </generator>
</set>

</framework>

</test>

</test set>

The framework place holder (cookie) is of the form:

TABLE 2

<framework directive=CombineCONCAT>

{list of engine models to instantiate}

</framework>

This directive tells the framework to combine and concatenate the results received from the different sets as described above. The purpose of this directive is to control the size of the final abstract test suite by limiting the size of the combination of the results of apiCHOICE and api3.

The input to model 210 (the SID engine called “apiCHOICE”) is as follows:

TABLE 3

<model name=apiCHOICE>

<choice>

<framework> <generator model=api1 engine=FOCUS>
</generator> </framework>
<framework> <generator model=api2 engine=FOCUS>
</generator> </framework>

</choice>

</model>

The designation “<framework>” indicates to the SID engine that this part of the model should be disregarded by the SID engine (since it identifies a FOCUS engine command) and treated as an opaque, i.e., as though it were not there.

The framework directives in the above example are of the form:

TABLE 4

<framework> <generator model=api1
engine=FOCUS> </generator> </framework>
<framework> <generator model=api2
engine=FOCUS> </generator> </framework>

These directive tell the framework to obtain the models called api1 and api2 from the FOCUS engine.

Breaking out api1 reveals the following FOCUS inputs:

TABLE 5

model api1

attribute: att1
value: value 1
value: value 2
attribute: att2
value=<framework model=port engine=FOCUS>

model port

attribute: port
value: default
value: notDefault

Breaking out api2 reveals the following FOCUS inputs:

TABLE 6

model api2

attribute: att1
value: value 1
value: value 2

Breaking out api3 reveals the following FOCUS inputs:

TABLE 7

model api3

attribute: att1
value: value1
value: value2
attribute: att2
value: value1
value: value 2

The following is a “walk-through” of the example described above. The framework begins by attempting to expand the first (and only) template test (Table 1). The framework place holder lists two models (apiCHOICE and api3) from two different engines (SID and FOCUS, respectively). The framework processes them in the order they are given. First the framework obtains the SID model (apiCHOICE) from the SID engine.

The SID engine produces the following two abstract tests:

TABLE 8

<test>

<framework> <generator model=api1 engine=FOCUS>
</generator> </framework>

</test>
<test>

<framework> <generator model=api2 engine=FOCUS>
</generator> </framework>

</test>

The result is that the framework now has two intermediate representations (also called tests):

TABLE 9

<test set>

<framework directive=CombineCONCAT>
<set>

<generator engine=FOCUS model=api1> </generator>
<generator engine=FOCUS model=api2> </generator>

</set>
<set>

<generator engine=FOCUS model=api3> </generator>

</set>
</framework>

</test set>

At this stage the framework calls the FOCUS engine to process the three FOCUS models, namely, api1, api2 and api3. The output of the FOCUS engine is as follows:

For model api1:

TABLE 10

<test<api1<att1 value 1><att2<framework model=port
engine=FOCUS/framework> >/test>
<test<api1<att1 value 2><att2<framework model=port
engine=FOCUS/framework> >/test>

For model api2:

TABLE 11

<test<api1<att1 value 1>>/test>
<test<api2<att1 value 2>>/test>

For model api3:

TABLE 12

<test api3<att1 value 1><att2 value 1>/test>
<test api3<att1 value 1><att2 value 2>/test>
<test api3<att1 value 2><att2 value 1>/test>
<test api3<att1 value 2><att2 value 2>/test>

Thus, the framework input, broken out, now looks as follows:

TABLE 13

<test set>

<framework directive=CombineCONCAT>
<set>

<test<api1<att1 value1><att2<framework model=port
engine=FOCUS/framework>>/test>
<test<api1<att1 value 2><att2<framework model=port
engine=FOCUS/framework>>/test>

<test<api2<att1 value 1>>/test>
<test<api2<att1 value 1>>/test>

</set>
<set>

<test api1<att1 value 1><att2 value 1>/test>
<test api3<att1 value 1><att2 value 2>/test>
<test api3<att1 value 2><att2 value 1>/test?
<test api3<att1 value2><att2 value 2>/test?

</set>
</framework>

</test set>

This defines two test sets (identified by the statements between the <set> and </set> designations). The framework uses the FOCUS tests to instantiate each template test. This is done according to the directive <framework directive=CombineCONCAT> appearing in the template tests to direct the combination of the results obtained from FOCUS. This directive requires that each result from the FOCUS generation stage will appear at least once. For example, in Table 12, there are shown four results between the first <set> and </set> designations, and four results between the second <set> and </set> designations. There are, thus, 4×4=16 ways to combine these two four-element result sets. CombineCONCAT selects only four out of the possible 16 combination results, assuming that a result from each test set appears at least once.

We thus obtain the following abstract tests:

TABLE 14
<test set>

<test>

<api1<att1 value 1><att2<framework model=port engine=FOCUS></framework>>>
<api3<att1 value 1><att2 value 1>

</test>
<test>

<api1<att1 value 2><att2<framework model=port engine=FOCUS></framework>>>
<api3<att1 value 2><att2 value 1>>

</test>
<test>

<api1<att1 value 1>>
<api3<att1 value 1><att2 value 2>>

</test>
<test>

<api2<att1 value 2>>
<api3<att1 value 2><att2 value 2>>

</test>

</test set>

At this stage it can be seen that two tests (the last two) have been fully expanded and contain no place holders, and two tests (the first two) still contain place holders. The framework continues to instantiate tests from these two templates using the FOCUS engine with the results of the port model detailed below:

For model port:

TABLE 15

<test port<port default>/test>
<test port<port notdefault>/test>

When no directive appears, the default is assumed which is to generate one test element, i.e., <test>, </test>, for each result of the port model by exchanging the cookie with a <test>, </test> result of the FOCUS engine. The framework uses FOCUS's results to obtain the following abstract tests:

TABLE 16

<test set>

<test>

<api1<att1 value 1><att2<port<port defaut>>>

<api3<att1 value 1><att2 value 1>
</test>
<test>

<api1<att1 value 1><att2<port<port notdefaut>>>
<api3<att1 value 1><att2 value 1>

</test>
<test>

<api1<att1 value 2><att2<port<port notdefaut>>>
<api3<att1 value 2><att2 value 1>>

</test>
<test>

<api1<att1 value 2><att2<port<port notdefaut>>>
<api3<att1 value 2><att2 value 1>>

</test>
<test>

<api2<att1 value 1>>
<api3<att1 value 1><att2 value 2>>

</test>
<test>

<api2<att1 value 2>>
<api3<att1 value 2><att2 value 2>>

</test>

</test set>

As can be seen, there are no cookies remaining; all tests have been fully expanded, resulting in the final abstract test which has been developed using test engines of different formats.

The test generation framework of the present invention provides means to combine the output of diverse test generators to obtain fully specified abstract test cases, thereby resulting in a more complete and realistic test model. Thus, it might combine optimal parameter values from one test generator with a sequence of function calls from another generator. This capability solves the problem posed by the propensity of the prior art test generators to generate incomplete abstract tests. The present invention largely eliminates the need to hard code parts of models (e.g., writing a program in Java or C that specifies the appropriate parameters that will call they different API's).

As described above, the use of abstraction naturally decomposes the generation of a complete test into a set of smaller tests and this requires a plurality of test generators. The activity of the multiple test generators must be coordinated, and as described above, the present invention enables this coordination.

Although the present invention has been described with respect to a specific preferred embodiment thereof, various changes and modifications may be suggested to one skilled in the art and it is intended that the present invention encompass such changes and modifications as fall within the scope of the appended claims.

We claim:

1. A method for integrating the use of a plurality of test-generators to generate a test suite for testing computer software, comprising the steps of
developing coverage criteria for said computer software;
determining a test sequence for satisfying said coverage criteria using said plurality of test generators individually;
compiling an intermediate representation of said test sequence; and
running said intermediate representation using said set of test generators in an integrated manner to generate said test suite.

2. A method as set forth in claim 1, wherein said compiling step comprises at least the steps of:
identifying test sequences containing test-generator-specific elements; and
replacing said test-generator-specific elements with generic directives which hide said test-generator-specific elements.

3. A method as set forth in claim 2, wherein said generic directives comprise cookies containing said test-generator-specific elements.

4. A method as set forth in claim 3, wherein said test-generator-specific elements comprise test models.

5. A system for integrating the use of a plurality of test-generators to generate a test suite for testing computer software, comprising:
means for developing coverage criteria for said computer software;
means for determining a test sequence for satisfying said coverage criteria using said plurality of test generators individually;
means for compiling an intermediate representation of said test sequence; and
means for running said intermediate representation using said set of test generators in an integrated manner to generate said test suite.

6. A system as set forth in claim 5, wherein said means for compiling comprises at least:
means for identifying test sequences containing test-generator-specific elements; and
means for replacing said test-generator-specific elements with generic directives which hide said test-generator-specific elements.

7. A system as set forth in claim 6, wherein said generic directives comprise cookies containing said test-generator-specific elements.

8. A method as set forth in claim 7, wherein said test-generator-specific elements comprise test models.

9. A computer program product for integrating the use of a plurality of test-generators to generate a test suite for testing computer software, comprising:
computer readable program code means for developing coverage criteria for said computer software;
computer readable program code means for determining a test sequence for satisfying said coverage criteria using said plurality of test generators individually;
computer readable program code means for compiling an intermediate representation of said test sequence; and
computer readable program code means for running said intermediate representation using said set of test generators in an integrated manner to generate said test suite.

10. A computer program product as set forth in claim 9, wherein said computer readable program code means for compiling comprises at least:
computer readable program code means for identifying test sequences containing test-generator-specific elements; and
computer readable program code means for replacing said test-generator-specific elements with generic directives which hide said test-generator-specific elements.

11. A system as set forth in claim 10, wherein said generic directives comprise cookies containing said test-generator-specific elements.

12. A system as set forth in claim 11, wherein said test-generator-specific elements comprise test models.
